(19) United States
(12) Patent Application Publication
(10) Pub. No.: US 2014/0225331 A1
(43) Pub. Date: Aug. 14, 2014

(54) LEVER SEALING STRUCTURE AND ELECTRIC TOOL PROVIDED THEREWITH

(71) Applicant: OMRON Corporation, Kyoto-shi (JP)

(72) Inventors: Akihiro Hozumi, Okayama (JP); Taiki Koyama, Okayama (JP); Minoru Kobayashi, Okayama (JP)

(73) Assignee: OMRON CORPORATION, Kyoto-shi (JP)

(21) Appl. No.: 14/168,087

(22) Filed: Jan. 30, 2014

(30) Foreign Application Priority Data
Feb. 14, 2013 (JP) 2013-026833
Oct. 23, 2013 (JP) 2013-220427

(51) Int. Cl. H01H 9/04

(52) U.S. Cl. CPC H01H 9/04
USPC 277/500

(57) ABSTRACT

An operating-lever sealing structure has an operating lever turnably attached to a housing of a switch, a shaft portion projected immediately below a guard portion of the operating lever that is turnably supported in an operation hole made in a bottom surface of a fitting recess of the housing, and a sealing ring that is sandwiched between the bottom surface of the fitting recess and a ceiling surface of the guard portion of the operating lever.

### BACKGROUND OF THE INVENTION

1. Technical Field

The present invention relates to a sealing structure of an operating lever, for example, a forward and reverse switching operating lever used in a trigger switch of an electric tool.

2. Related Art

As to the conventional sealing structure of the operating lever used in the trigger switch of the electric tool, for example, in a waterproof structure disclosed in Japanese Unexamined Patent Publication No. 2011-51079, a groove portion is provided in a whole circumference of a turning support, a packing is fitted in the groove portion, and a foreign substance invasion passage between the packing and the turning support is formed into a labyrinth structure.

### SUMMARY

However, in the waterproof structure, as illustrated in FIG. 4, a sealing property may be established only by a substantial line contact between a ring-shaped packing 16 and a switch case 13, and a highly-reliable sealing structure may be difficult to obtain because of a short sealing surface distance.

One or more embodiments of the present invention provides a highly reliable operating-lever sealing structure having the long surface distance between the sealing ring and the housing.

In accordance with one or more embodiments of the present invention, in an operating-lever sealing structure in which an operating lever is turnably attached to a housing of a switch, a shaft portion projected immediately below a guard portion of the operating lever is turnably supported in an operation hole made in a bottom surface of a fitting recess of the housing, and a sealing ring is sandwiched between the bottom surface of the fitting recess and a ceiling surface of the guard portion of the operating lever.

According to one or more embodiments of the present invention, the sealing ring is vertically sandwiched, the sealing surface distance is lengthened. Particularly, the sealing ring is always in contact with the two positions, that is, the bottom surface of the fitting recess of the housing and the ceiling surface of the guard portion of the operating lever with a pressure, advantageously the sealing surface distance is lengthened to obtain the operating-lever sealing structure having the highly reliable sealing property.

In the operating-lever sealing structure, the guard portion of the operating lever may have a planar shape that covers the fitting recess. Accordingly, because the guard portion of the operating lever covers the fitting recess of the housing, the water hardly invades even if the water is splashed. Therefore, the water is hardly collected in the fitting recess, and the highly reliable sealing structure is obtained.

In the operating-lever sealing structure, a cyclic gap may be formed between an outer circumferential surface of the shaft portion and the sealing ring. Accordingly, the sealing ring can surely be sandwiched from top and bottom to further improve the reliability of the sealing property.

In the operating-lever sealing structure, at least one position regulating cyclic groove portion in which the sealing ring is fitted may be provided in at least one of the bottom surface of the fitting recess and the ceiling surface of the guard portion of the operating lever, the bottom surface of the fitting recess and the ceiling surface of the guard portion of the operating lever being opposed to each other. Accordingly, the sealing ring can accurately be positioned, and the contact area of the sealing ring increases to further improve the reliability of the sealing property.

In the operating-lever sealing structure, the sealing ring may have an elliptical shape in cross-section, a circular shape in cross-section, or a square shape in cross-section. Accordingly, the sealing ring having the desired cross-sectional shape can be selected as needed basis, and a degree of design freedom is enhanced.

In the operating-lever sealing structure, a plurality of concentrically-disposed sealing rings may be sandwiched between the bottom surface of the fitting recess and the ceiling surface of the guard portion of the operating lever. Accordingly, a pressure-contact point of the sealing ring with respect to the housing and the operating lever increases to further improve the reliability.

In the operating-lever sealing structure, an uplift regulating rib may be provided in the housing in order to abut on an upper surface of the guard portion of the operating lever to regulate uplift. Accordingly, the uplift of the operating lever is regulated to always sandwich the sealing ring in a constant pressure-contact state, so that the reliability can further be improved.

In accordance with one or more embodiments of the present invention, in an operating-lever sealing structure in which a shaft portion of an operating lever is turnably supported in an operation hole made in a housing of a switch, a sealing ring is sandwiched between an inside opening edge portion of the operation hole of the housing and a guard portion provided in an outer circumferential surface of the shaft portion of the operating lever.

According to one or more embodiments of the present invention, because the sealing ring is sandwiched between the housing and the guard portion of the operating lever, the sealing surface distance is lengthened. Particularly, the sealing ring is always in contact with the two positions, that is, the housing and the operating lever with a pressure. Therefore, advantageously the sealing surface distance is lengthened to obtain the operating-lever sealing structure having the highly reliable sealing property.

In an operating-lever sealing structure of one or more embodiments of the present invention, the sealing ring may have a T-shape in cross-section and an inner circumferential surface of the sealing ring includes a cyclic ridge, or the sealing ring may include a C-shape in cross-section and an inner circumferential surface of the sealing ring includes a cyclic groove portion.

In the sealing ring including the T-shape in cross-section, when the sealing ring is sandwiched between the housing and the guard portion of the operating lever, the cyclic ridge is pushed out inward to come into contact with the shaft portion of the operating lever with the pressure, and the whole of the sealing ring is pressed outward by a reaction force of the contact with the pressure. Therefore, an adhesion property is enhanced between the seal ring and the operation hole to obtain the high sealing property.

In the sealing ring including the C-shape in cross-section, the contact area between the sealing ring and the housing increases to further improve the sealing property. Because the cyclic groove portion is formed in the inside surface of the sealing ring, an elastic deformation is easily generated and an operation feeling of the operating lever is improved. Even if the water invades into the cyclic groove portion of the sealing ring, the sealing ring is pushed and extended outward by a water pressure to enhance the sealing property. Therefore, advantageously the operating-lever sealing structure having the higher sealing property is obtained while desired operability is ensured.

In accordance with still one or more embodiments of the present invention, an electric tool includes a switch that includes the operating-lever sealing structure. According to one or more embodiments of the present invention, advantageously the electric tool having the highly reliable sealing structure in the operating lever of the switch is obtained.

### BRIEF DESCRIPTION OF THE DRAWINGS

FIG. 1 is a perspective view illustrating an operating-lever sealing structure according to a first embodiment of the present invention;

FIG. 2 is an exploded perspective view illustrating the operating-lever sealing structure in FIG. 1;

FIG. 3 is an exploded perspective view illustrating the operating-lever sealing structure in FIG. 1 viewed from a different angle;

FIGS. 4A and 4B are a cross-sectional view and a partially enlarged cross-sectional view illustrating the operating-lever sealing structure in FIG. 1;

FIGS. 5A and 5B are a cross-sectional view and a partially enlarged cross-sectional view illustrating an operating-lever sealing structure according to a second embodiment of the present invention;

FIGS. 6A and 6B are a cross-sectional view and a partially enlarged cross-sectional view illustrating an operating-lever sealing structure according to a third embodiment of the present invention;

FIGS. 7A and 7B are a cross-sectional view and a partially enlarged cross-sectional view illustrating an operating-lever sealing structure according to a fourth embodiment of the present invention;

FIGS. 8A and 8B are a cross-sectional view and a partially enlarged cross-sectional view illustrating an operating-lever sealing structure according to a fifth embodiment of the present invention;

FIGS. 9A and 9B are a cross-sectional view and a partially enlarged cross-sectional view illustrating an operating-lever sealing structure according to a sixth embodiment of the present invention;

FIGS. 10A and 10B are a cross-sectional view and a partially enlarged cross-sectional view illustrating an operating-lever sealing structure according to a seventh embodiment of the present invention;

FIG. 11 is a perspective view illustrating an operating-lever sealing structure according to an eighth embodiment of the present invention;

FIG. 12 is an exploded perspective view illustrating the operating-lever sealing structure in FIG. 11;

FIG. 13 is an exploded perspective view illustrating the operating-lever sealing structure in FIG. 11 viewed from a different angle;

FIGS. 14 A and 14B are a cross-sectional view and a partially enlarged cross-sectional view illustrating the operating-lever sealing structure in FIG. 11;

FIGS. 15 A and 15B are perspective views illustrating an operating lever in FIG. 12 viewed from different angles;

FIGS. 16A and 16B are a plan view and a cross-sectional view illustrating a sealing ring in FIG. 12; and

FIGS. 17A and 17B are a plan view and a cross-sectional view illustrating a sealing ring used in an operating-lever sealing structure according to a ninth embodiment of the present invention.

### DETAILED DESCRIPTION

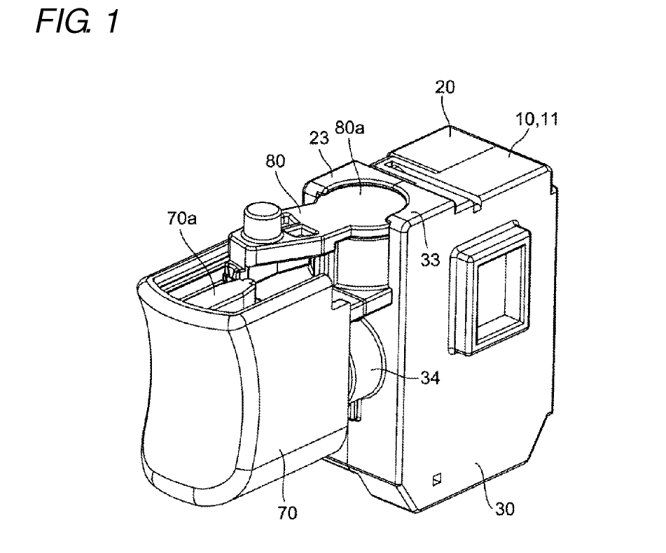

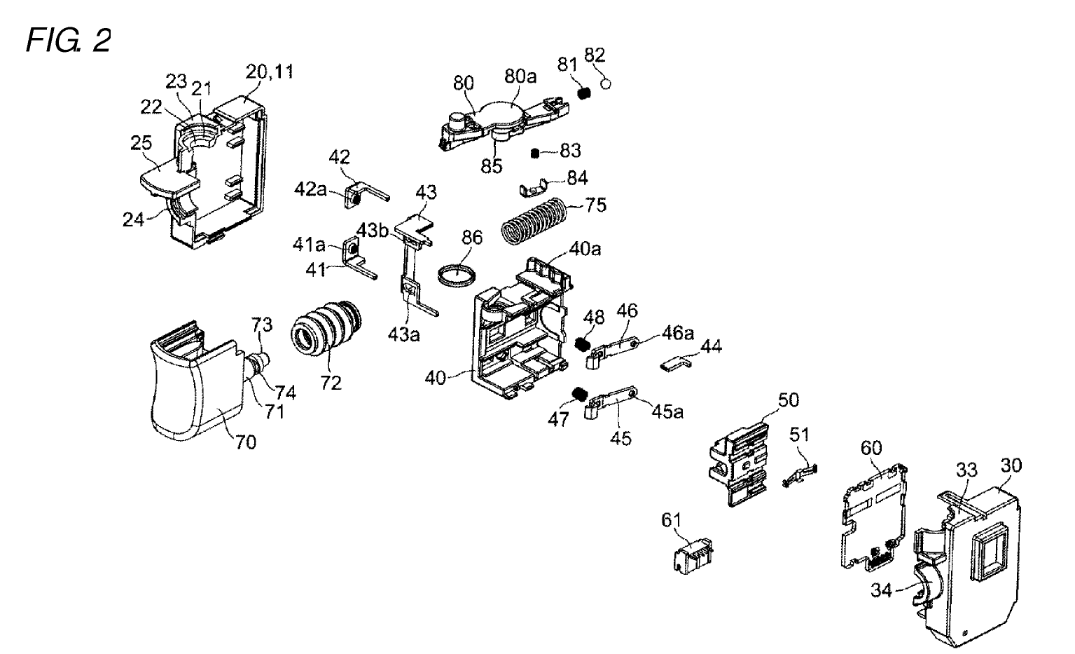

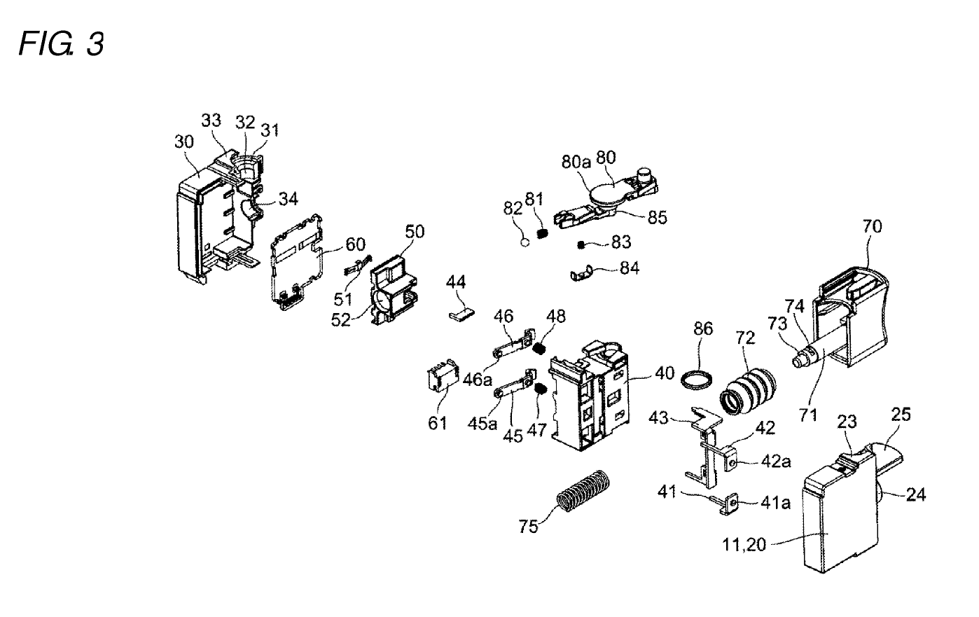

Embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. As illustrated in FIGS. 1 to 4, an operating-lever sealing structure according to a first embodiment is applied to a trigger switch 10 of an electric drill. As illustrated in FIGS. 2 and 3, a trigger 70 and an operating lever 80 are assembled in the trigger switch 10 while internal components such as a base 40, a plunger 50, and a printed board 60 are assembled in a housing 11 that is formed by combining a first cover 20 and a second cover 30.

As illustrated in FIG. 2, a semicircular fitting recess 21 is provided in an upper surface of the first cover 20 in order to support the operating lever 80, and a semicircular operation hole 22 is provided in a bottom surface of the fitting recess 21. In the first cover 20, a quadrant uplift regulating rib 23 is projected along an upper surface edge portion of the fitting recess 21. In the first cover 20, a semicircular rib 24 is provided in a lateral surface on one side in order to support an operating shaft 71 of the trigger 70, and a guide piece 25 is laterally projected.

As illustrated in FIG. 3, the second cover 30 has a front shape that can be butted to the first cover 20, a semicircular fitting recess 31 is provided in the upper surface of the second cover 30 in order to support the operating lever 80, and a semicircular operation hole 32 is provided in the bottom surface of the fitting recess 31. In the second cover 30, a quadrant uplift regulating rib 33 is projected along the upper surface edge portion of the fitting recess 31. In the second cover 30, a semicircular rib 34 is provided in a lateral surface on one side in order to support the operating shaft 71 of the trigger 70.

In a bonding surface of the second cover 30, the bonding surface except portions to which the trigger 70, the operating lever 80, and a connector 61 are to be attached is bonded to the first cover 20 by ultrasonic welding.

As illustrated in FIG. 2, a click feeling wavelike surface 40a is formed in the upper surface of the base 40. In the base 40, first and second fixed contact terminals 41 and 42 and a common terminal 43 are press-fitted from one side, and a switching contact terminal 44 is assembled from the other side. In the common terminal 43 press-fitted in the base 40, first and second moving contact pieces 45 and 46 are turnably supported while inserted in engagement holes 43a and 43b made in an extending portion projected from the common terminal 43. By assembling positioning helical springs 47 and 48 in the base 40, the first and second moving contact pieces 45 and 46 are biased so as to automatically return without dropping out. Therefore, first and second moving contacts 45a and 46a of the first and second moving contact pieces 45 and 46 are opposed to first and second fixed contacts 41a and 42a of the first and second fixed contact terminals 41 and 42 so as to be able to come into contact with and separate from the first and second fixed contacts 41a and 42a, respectively.

The plunger 50 is slidably fitted in the base 40, and a slider 51 is assembled in an outward side surface of the plunger 50. The slider 51 attached to the outward side surface of the plunger 50 slides along a slide resistor (not illustrated) of the printed board 60, which will be described below, thereby changing a resistance value.

The printed board 60 has a front shape that can be accommodated in the first and second covers 20 and 30, the connector 61 is electrically connected to the printed board 60, and the slide resistor (not illustrated) is printed in an inward surface of the printed board 60. The printed board 60 is positioned in the base 40 accommodating the plunger 50, and the first and second fixed contact terminals 41 and 42, the common terminal 43, and the switching contact terminal 44, which are assembled in the base 40, are electrically connected to the printed board 60, whereby the printed board 60 is integrated with the base 40.

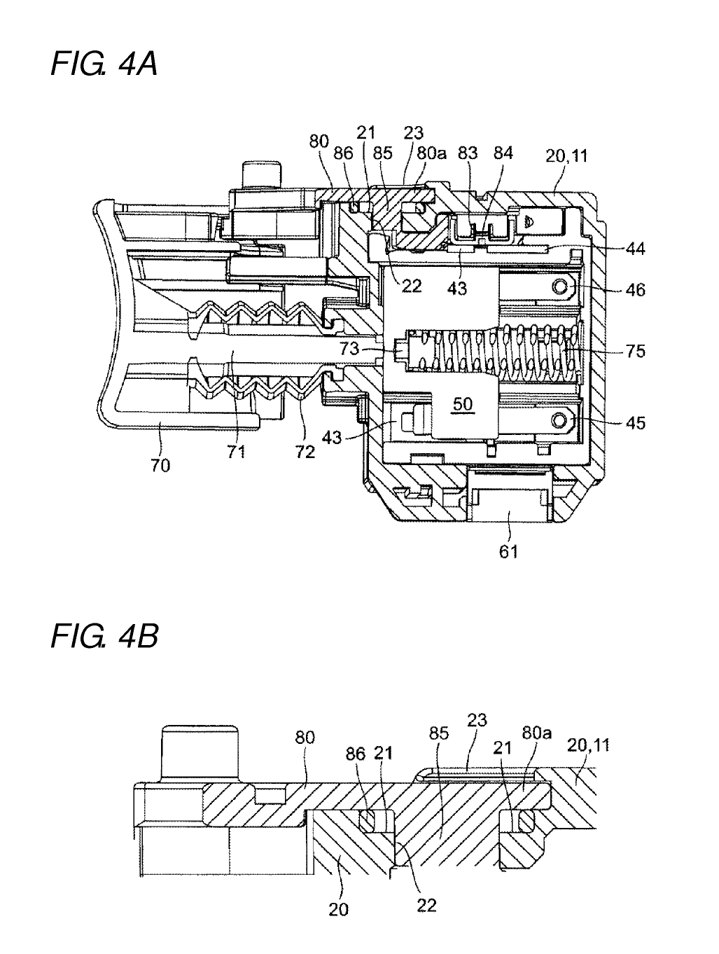

In the trigger 70, the laterally projecting operating shaft 71 is inserted in a bellows cylindrical body 72, a notch groove 74 provided near a projected leading end portion 73 is engaged with the plunger 50, and the leading end portion 73 is fitted in one end portion of a return helical spring 75. The other end portion of the return helical spring 75 projects from a through-hole 52 (FIG. 3) of the plunger 50 and abuts on the inside surface of the base 40. Therefore, the return helical spring 75 biases the trigger 70 and the plunger 50 so as to push the trigger 70 and the plunger 50 outward from the housing 11. As illustrated in FIG. 4, one end portion of the bellows cylindrical body 72 is elastically fitted in a base portion of the operating shaft 71 while the other end portion is elastically fitted in the ribs 24 and 34 of the first and second covers 20 and 30 butted to each other, thereby preventing water from infiltrating from surroundings of the operating shaft 71.

As illustrated in FIGS. 2 and 3, a steel ball 82 is assembled in one end portion of the operating lever 80 with an operating-lever helical spring 81 interposed therebetween so as to be biased outward, and a moving contact 84 is assembled in a lower surface on one end side of the operating lever 80 with a switching helical spring 83 interposed therebetween. A shaft portion 85 that is projected immediately below a guard portion 80a of the operating lever 80 is turnably supported by the semicircular operation holes 22 and 32 of the first and second covers 20 and 30. A sealing ring 86 is disposed in the semicircular fitting recesses 21 and 31 of the first and second covers 20 and 30, whereby the sealing ring 86 is sandwiched between the bottom surfaces of the fitting recesses 21 and 31 and a ceiling surface of the guard portion 80a of the operating lever 80. In the first embodiment, as illustrated in FIG. 4, a highly reliable sealing structure is obtained because the housing 11 has a long surface distance from the outside to the inside. Because the guard portion 80a of the operating lever 80 covers the fitting recess 21 of the housing 11, the water is hardly collected in the fitting recess 21 even if the water is splashed, and advantageously the more highly reliable sealing structure is obtained.

Accordingly, the internal components are assembled in the first and second covers 20 and 30. Then the operating shaft 71 of the trigger 70 is sandwiched between the first and second covers 20 and 30, and the other end portion of the bellows cylindrical body 72 is elastically fitted in the ribs 24 and 34 of the first and second covers 20 and 30. Then the bonding surfaces of the first and second covers 20 and 30 are integrated with each other by the ultrasonic welding to complete assembly work of the trigger switch 10.

An operation of the trigger switch will briefly be described below. When the operating lever 80 is located at a neutral position, one end portion of the operating lever 80 abuts on a central projection 70a of the trigger 70, whereby a wrong operation is prevented while the trigger 70 is not dragged. Immediately before the trigger 70 is dragged after the operating lever 80 is rotated counterclockwise, the slider 51 comes into contact with the slide resistor (not illustrated) of the printed board 60 with the maximum resistance value. On the other hand, the first and second moving contact pieces 45 and 46 are biased by the helical springs 47 and 48, and the first and second moving contacts 45a and 46a are separated from the first and second fixed contacts 41 a and 42a.

When a worker slightly drags the trigger, the plunger 50 engaged with the operating shaft 71 slides. Therefore, the first moving contact piece 45 turns, and the first moving contact 45a comes into contact with the first fixed contact 41a. As a result, a small current passes to start rotation of a motor (not illustrated) at low speed.

As the trigger 70 is dragged to slide the slider 51 assembled in the plunger 50 on the slide resistor of the printed board 60, a resistance decreases, the current increases, and the number of rotations of the motor increases.

When the trigger 70 is further dragged to push the operating shaft 71 into the deep side of the base 40, the second moving contact piece 46 turns, and the second moving contact 46a comes into contact with the second fixed contact 42a to cause the maximum current to flow therethrough, and the number of rotations of the motor becomes the maximum.

When the worker weakens a force to drag the trigger 70, the plunger 50 and the operating shaft 71 are pushed back to return to original states by the spring force of the return helical spring 75. Therefore, the rotation of the motor gradually slows down and stops.

On the other hand, the operating lever 80 is rotated clockwise about the shaft portion 85, the common terminal 43 and the switching contact terminal 44 are connected to each other by the moving contact 84, and the trigger 70 is likewise operated, which allows the motor to be reversely rotated.

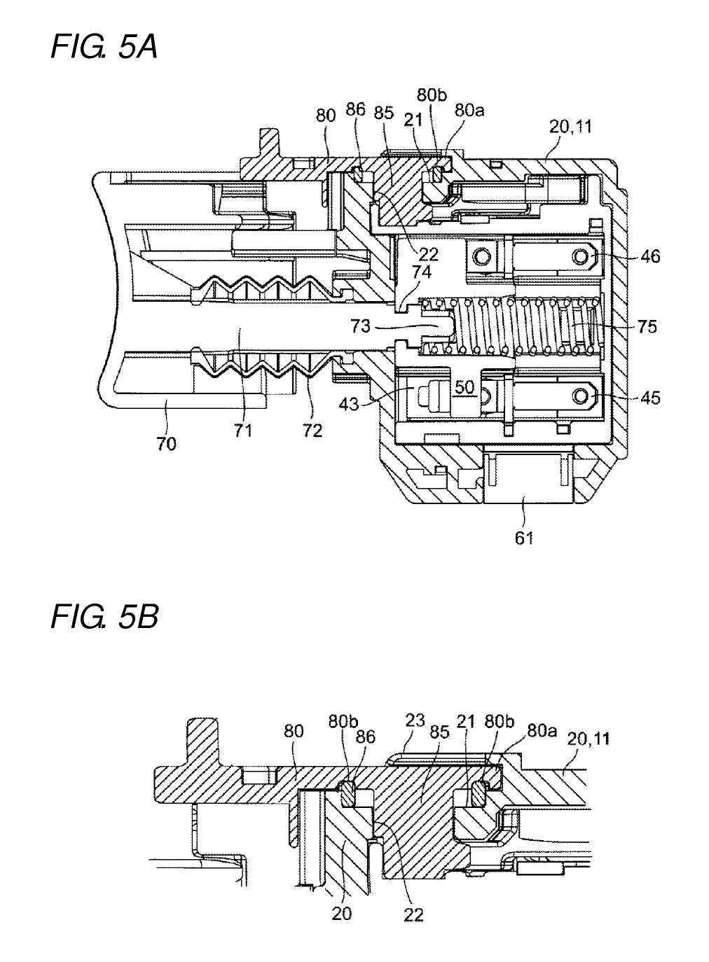

As illustrated in FIG. 5, an operating-lever sealing structure according to a second embodiment differs from that of the first embodiment only in that a position regulating cyclic groove portion 80b is provided in the ceiling surface of the operating lever 80 opposed to the bottom surfaces of the fitting recesses 21 and 31 of the housing 11. According to the second embodiment, the sealing ring 86 is fitted and positioned in the position regulating cyclic groove portion 80b, so that advantageously misregistration of the sealing ring 86 can be prevented to stably ensure a sealing property. Because other configurations of the second embodiment are similar to those of the first embodiment, similar components or similar portions are designated by the same numerals, and the description thereof is omitted.

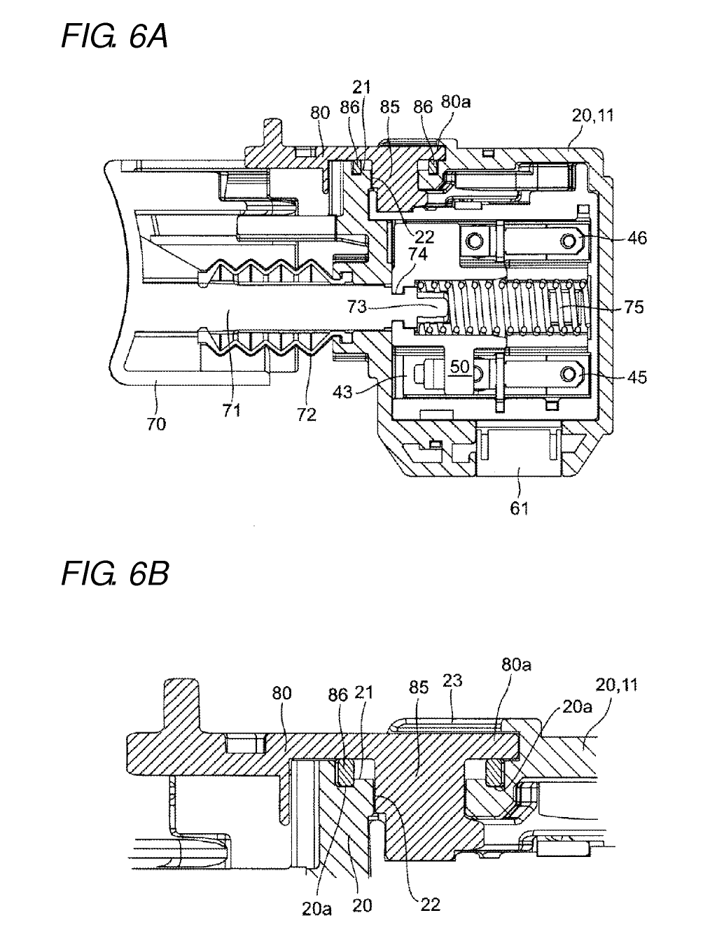

As illustrated in FIG. 6, an operating-lever sealing structure according to a third embodiment differs from that of the first embodiment only in that a position regulating cyclic groove portion 20a is provided in the bottom surfaces of the fitting recesses 21 and 31 opposed to the ceiling surface of the operating lever 80. According to the third embodiment, the sealing ring 86 is fitted and positioned in the position regulating cyclic groove portion 20a, so that advantageously the misregistration of the sealing ring 86 can be prevented to stably ensure the sealing property. Because other configurations of the third embodiment are similar to those of the first embodiment, similar components or similar portions are designated by the same numerals, and the description is omitted. The position regulating cyclic groove portions may be provided in the positions where the bottom surfaces of the fitting recesses 21 and 31 are opposed to the ceiling surface of the operating lever 80.

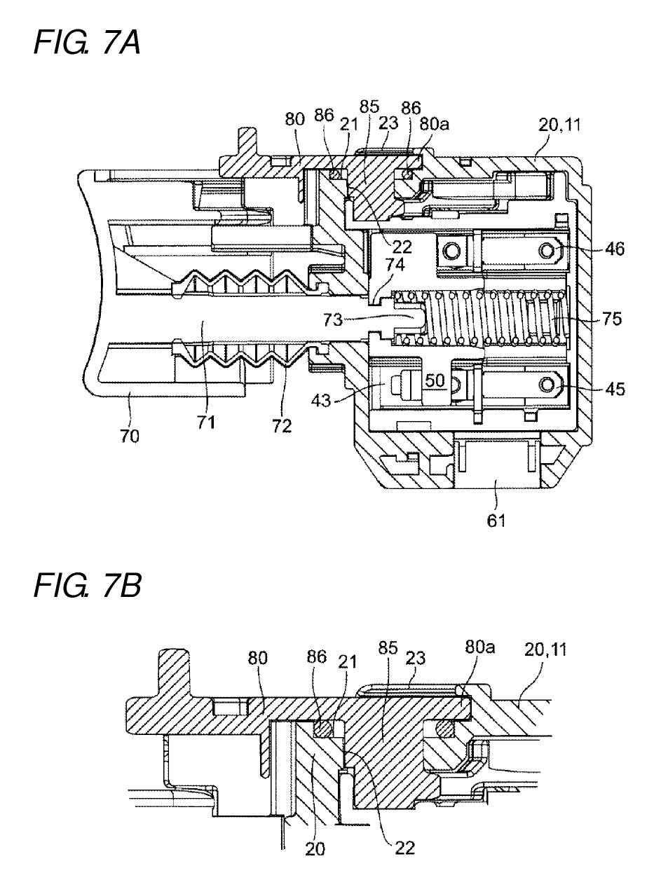

As illustrated in FIG. 7, an operating-lever sealing structure according to a fourth embodiment differs from that of the first embodiment only in that the sealing ring 86 has a circular shape in cross-section. According to the fourth embodiment, the easily-available sealing ring 86 having the circular shape in cross-section can be used to facilitate replacement work for maintenance. Because of a small contact area between the sealing ring 86 and the housing 11 and operating lever 80, advantageously the resistance is reduced during the operation. Because other configurations of the fourth embodiment are similar to those of the first embodiment, similar components or similar portions are designated by the same numerals, and the description is omitted.

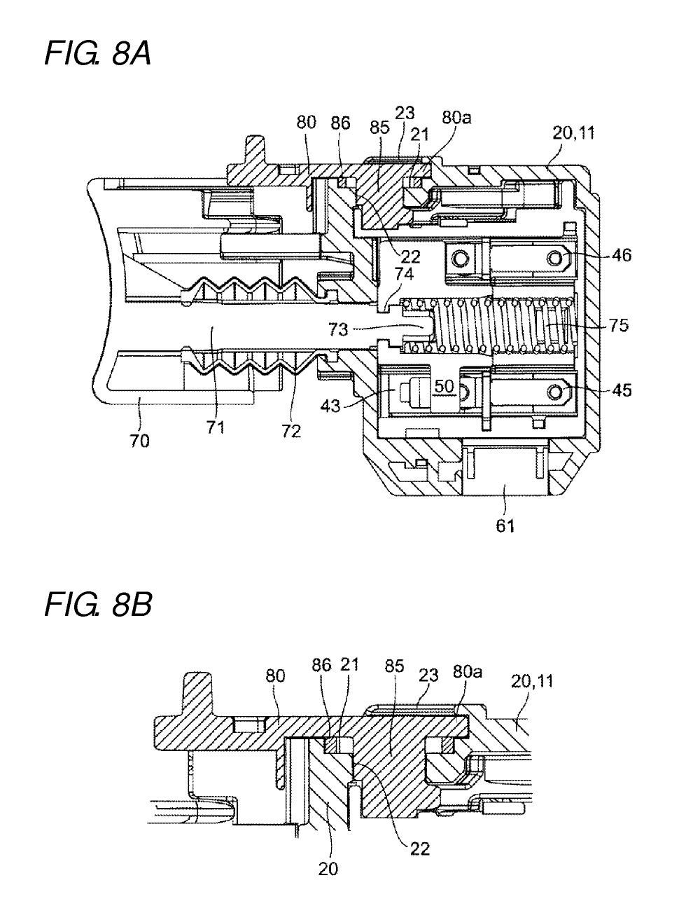

As illustrated in FIG. 8, an operating-lever sealing structure according to a fifth embodiment differs from that of the first embodiment only in that the sealing ring 86 has a square shape in cross-section. According to the fifth embodiment, advantageously the sealing ring 86 is in surface contact with the housing 11 and the operating lever 80 to obtain the more highly reliable sealing structure. Because other configurations of the fifth embodiment are similar to those of the first embodiment, similar components or similar portions are designated by the same numerals, and the description is omitted.

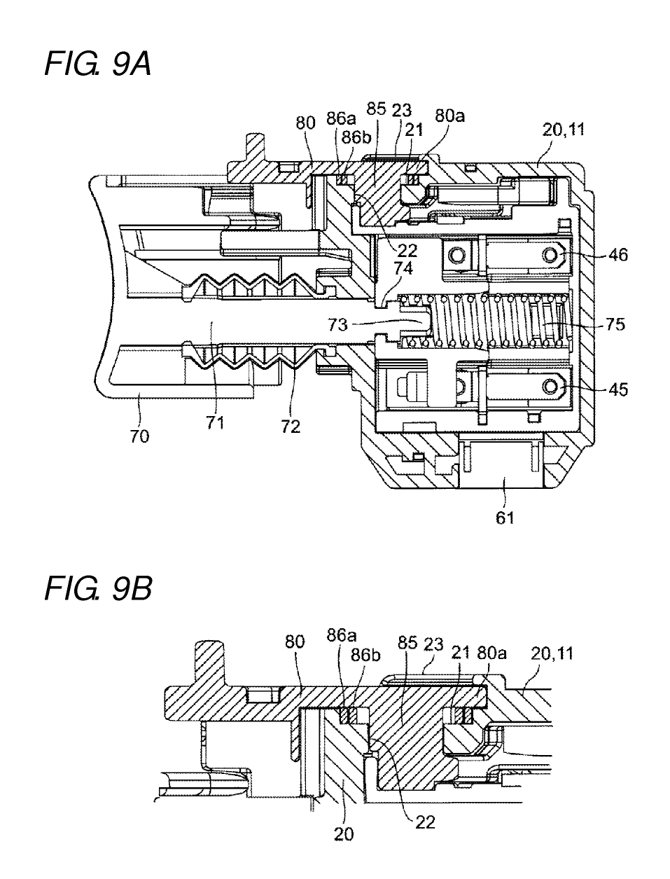

As illustrated in FIG. 9, an operating-lever sealing structure according to a sixth embodiment differs from that of the first embodiment only in that a double sealing structure is formed by two concentric sealing rings 86a and 86b. According to the sixth embodiment, advantageously the sealing property is further ensured to improve the reliability. Because other configurations of the sixth embodiment are similar to those of the first embodiment, similar components or the similar portions are designated by the same numerals, and the description is omitted.

At least three concentric sealing rings may be used, and the cross-sectional shape of the sealing ring may be the circular shape, the square shape, an elliptical shape, and a combination thereof. Alternatively, the plurality of sealing rings may concentrically be fitted and positioned in the plurality of position regulating cyclic groove portions provided in parallel or one wide position regulating cyclic groove portion.

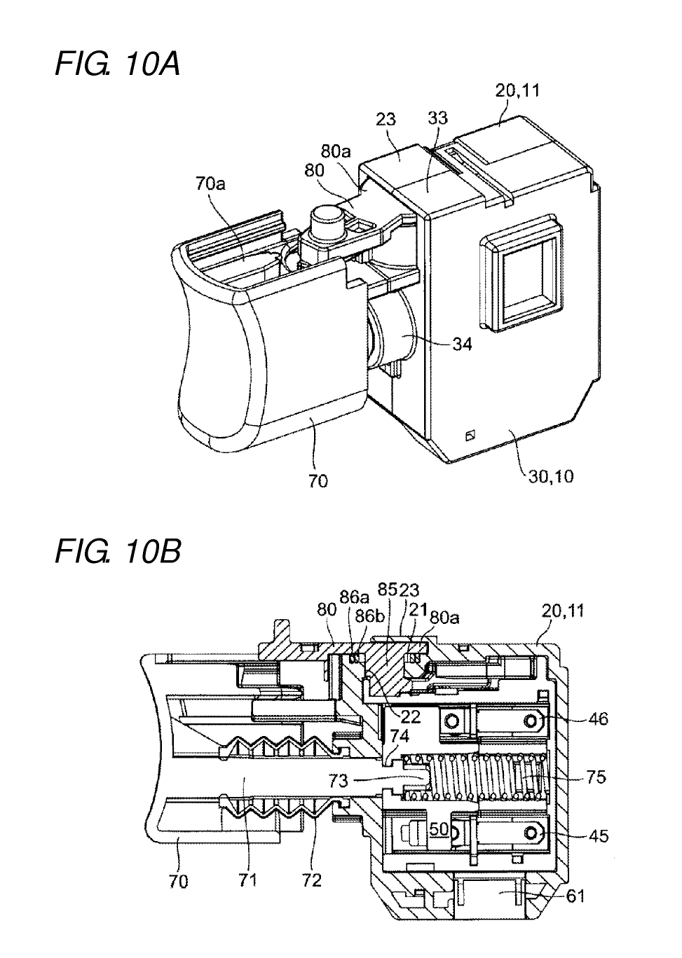

As illustrated in FIG. 10, an operating-lever sealing structure according to a seventh embodiment differs from that of the first embodiment only in that at least a half of the upper surface of the guard portion 80a of the operating lever 80 is position-regulated by the uplift regulating ribs 23 and 33 that are laterally extended from the upper surface of the housing 11. According to the seventh embodiment, the uplift of the guard portion 80a of the operating lever 80 can surely be regulated. Therefore, advantageously the sealing rings 86a and 86b are always in contact with the bottom surfaces of the fitting recesses 21 and 31 of the housing 11 and the ceiling surface of the guard portion 80a of the operating lever 80 with a constant pressure, and the sealing property is further ensured. Because other configurations of the seventh embodiment are similar to those of the first embodiment, similar components or similar portions are designated by the same numerals, and the description is omitted.

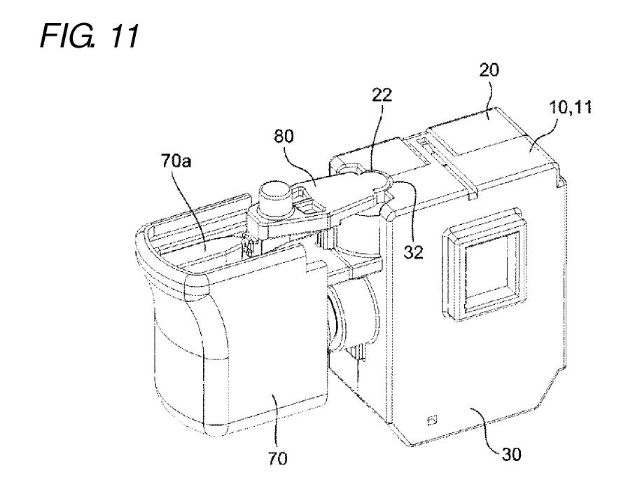

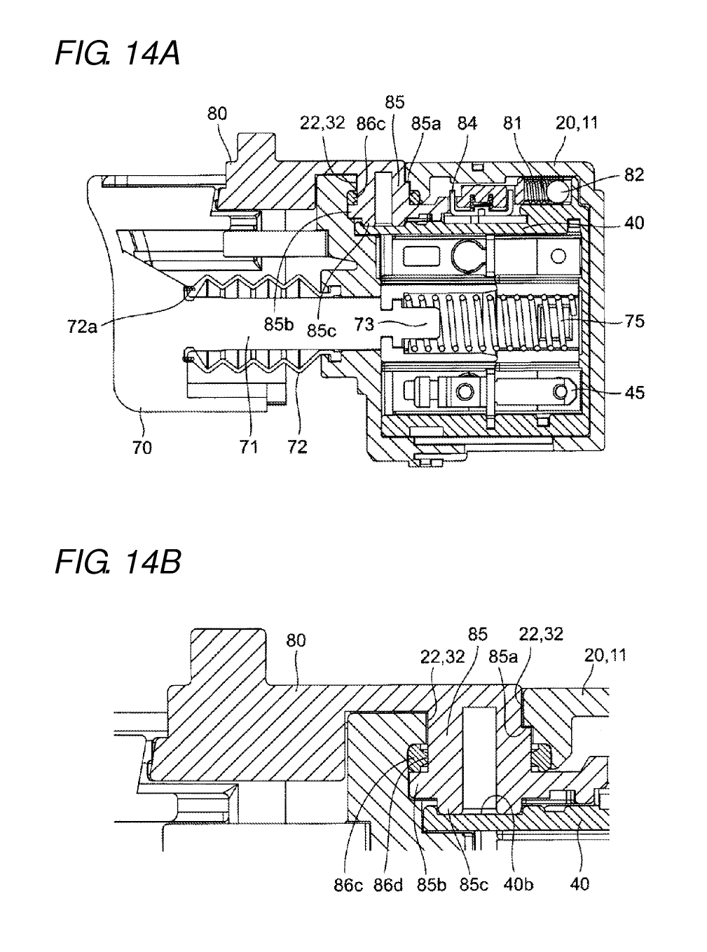

As illustrated in FIGS. 11 to 16, an operating-lever sealing structure according to an eighth embodiment is substantially similar to that of the first embodiment. However, as illustrated in FIG. 14, the operating-lever sealing structure of the eighth embodiment differs largely from that of the first embodiment in that a sealing ring 86c is vertically sandwiched between inside opening edge portions of the operation holes 22 and 32 of the first and second covers 20 and 30 and a guard portion 85b provided in the shaft portion of the operating lever 80.

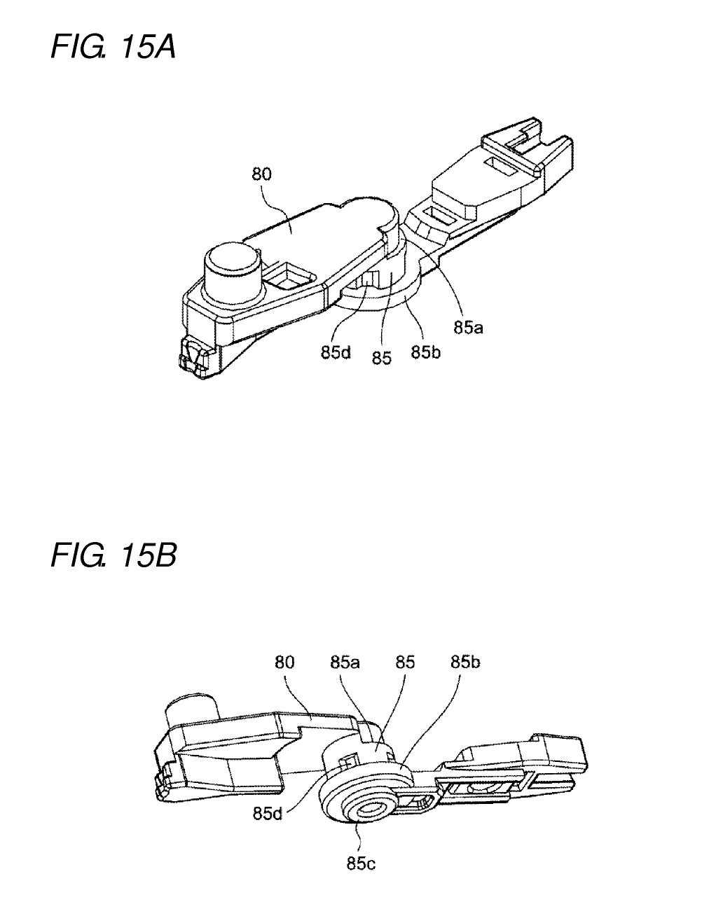

In the operating lever 80, as illustrated in FIG. 15, a retaining step portion 85a is formed on the upper side of the shaft portion 85 while the guard portion 85b is provided on the lower side of the shaft portion 85, and a shaft end portion 85c is coaxially formed in a lower surface of the guard portion 85b while being integral with the guard portion 85b. Turning prevention recesses 85d are provided at predetermined intervals in the outer circumferential surface of the shaft portion 85.

As illustrated in FIG. 16, a sealing ring 86c has a substantial T-shape in cross-section, and the inner circumferential surface of the sealing ring 86c includes a cyclic ridge 86d. By vertically sandwiching the sealing ring 86c, the cyclic ridge 86d is pushed out inward to come into press with the shaft portion 85 of the operating lever 80 with the pressure, and the whole of the sealing ring 86c is pressed outward by a reaction force of the contact with the pressure. An adhesion property is enhanced between the sealing ring 86c and the operation holes 22 and 32, and the contact area between the cyclic ridge 86d and the shaft portion 85 including the turning prevention recesses 85d is decreased. Therefore, the sealing ring 86c does not turn, but remains in close contact with the operation holes 22 and 32, so that the high sealing property can be obtained.

The sealing ring 86c may be used in the first to seventh embodiments.

As illustrated in FIG. 14B, the retaining step portion 85a of the operating lever 80 engages with the inside opening edge portions of the operation holes 22 and 32 to retain the operating lever 80.

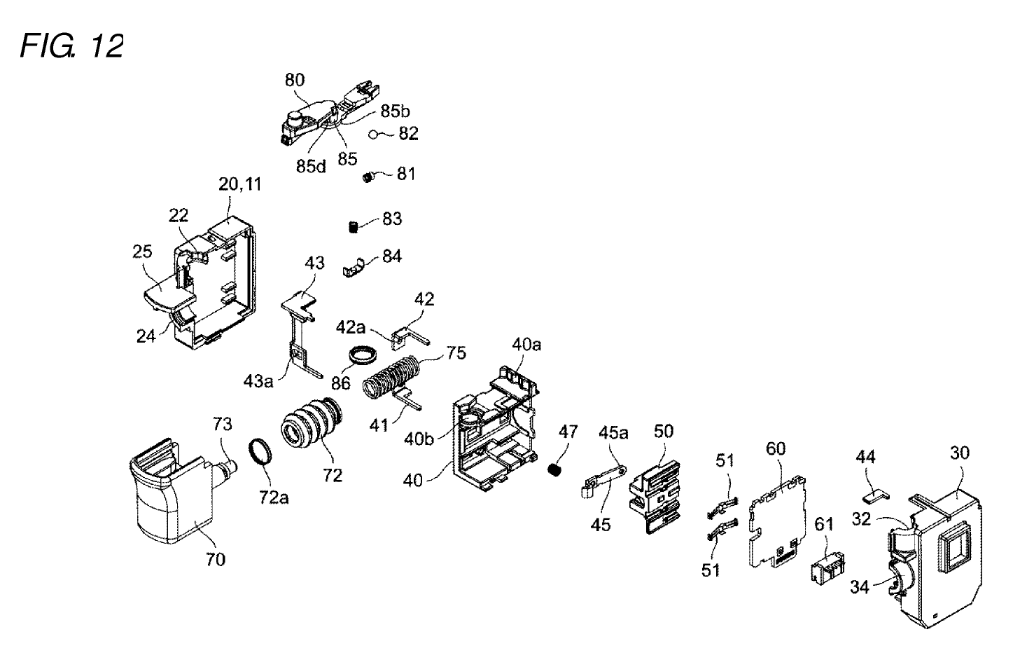

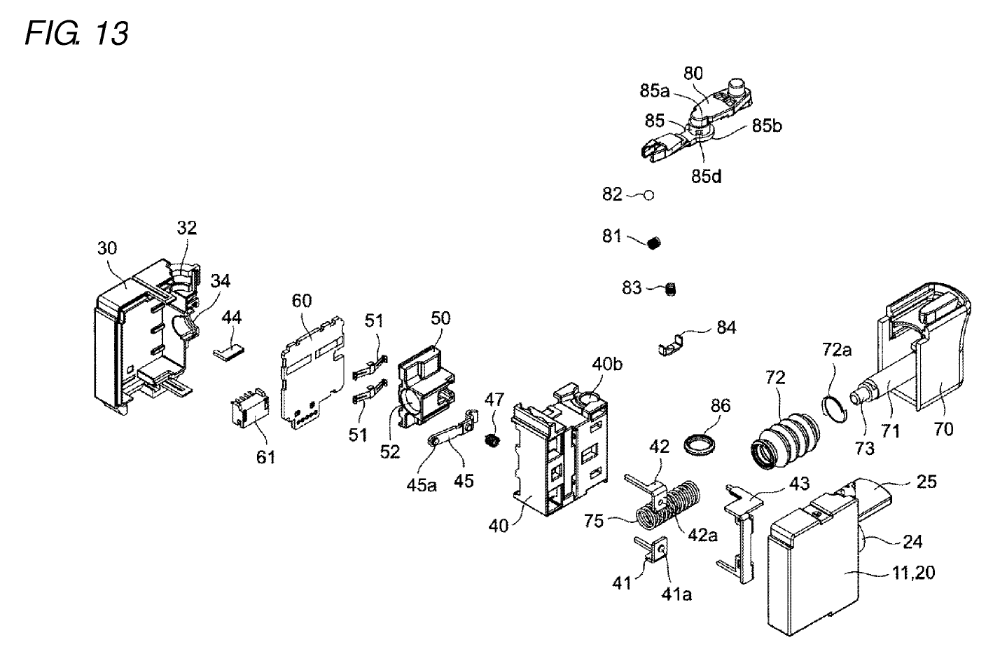

As illustrated in FIGS. 12 and 13, one end portion of the bellows cylindrical body 72 is attached to the trigger 70 with a retaining helical spring 72a interposed therebetween, thereby more surely retaining the operating lever 80.

Because other configurations of the eighth embodiment are similar to those of the first embodiment, similar components are designated by the same numerals, and the description thereof is not repeated.

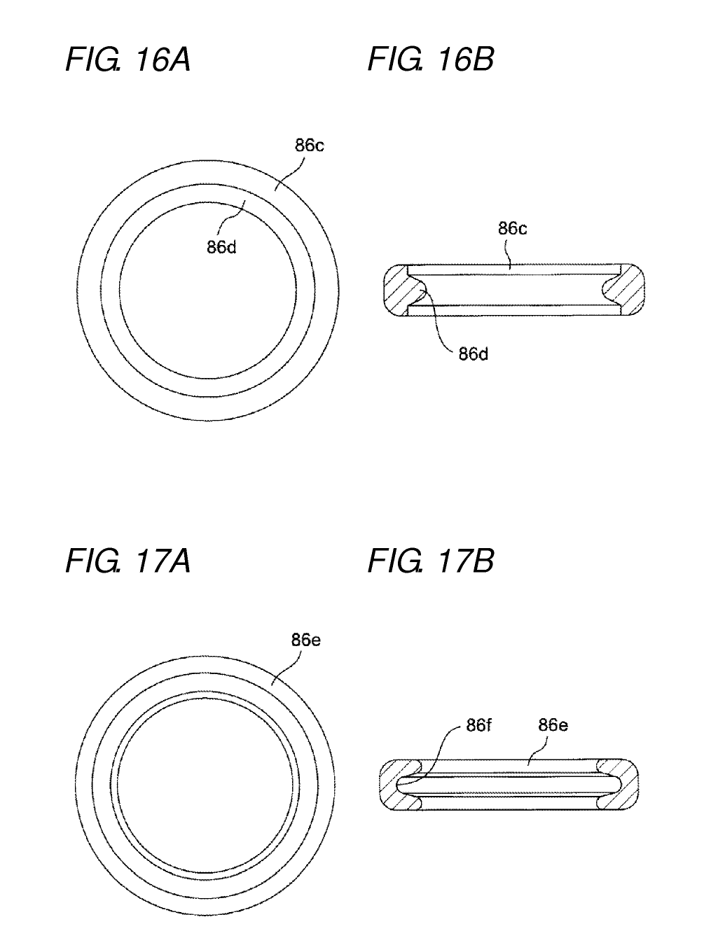

As illustrated in FIG. 17, a sealing ring 86e that can be applied to all the above embodiments is used in an operating-lever sealing structure according to a ninth embodiment. The sealing ring 86e has a substantial C-shape in cross-section, and a cyclic groove portion 86f is provided in the inner circumferential surface of the sealing ring 86e. Because other configurations of the ninth embodiment are similar to those of the above embodiments, similar components are designated by the same numerals, and the description thereof is not repeated. According to the ninth embodiment, the contact area between the sealing ring 86e and the housing 11 increases to enhance the sealing property. Particularly, because the cyclic groove portion 86f is provided in the inner circumferential surface of the sealing ring 86e, the operating lever 80 having the easy elastic deformation and good operation feeling is obtained. Even if the water invades into the cyclic groove portion 86f of the sealing ring 86e, the sealing ring 86e is pushed and extended outward by a water pressure to enhance the sealing property. Therefore, advantageously the operating-lever sealing structure having the higher sealing property is obtained while desired operability is ensured.

The operating-lever sealing structure according to one or more embodiments of the present invention can be applied not only to the trigger switch of the electric drill but also other electric tools.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An operating-lever sealing structure comprising:
an operating lever turnably attached to a housing of a switch;
a shaft portion projected immediately below a guard portion of the operating lever that is turnably supported in an operation hole made in a bottom surface of a fitting recess of the housing; and
a sealing ring that is sandwiched between the bottom surface of the fitting recess and a ceiling surface of the guard portion of the operating lever.

2. The operating-lever sealing structure according to claim 1, wherein the guard portion of the operating lever comprises a planar shape that covers the fitting recess.

3. The operating-lever sealing structure according to claim 1, wherein a cyclic gap is formed between an outer circumferential surface of the shaft portion and the sealing ring.

4. The operating-lever sealing structure according to claim 1,
wherein at least one position regulating cyclic groove portion in which the sealing ring is fitted is provided in at least one of the bottom surface of the fitting recess and the ceiling surface of the guard portion of the operating lever,
wherein the bottom surface of the fitting recess and the ceiling surface of the guard portion of the operating lever are opposed to each other.

5. The operating-lever sealing structure according to claim 1, wherein the sealing ring comprises a cross-section having an elliptical shape.

6. The operating-lever sealing structure according to claim 1, wherein the sealing ring comprises a cross-section having a circular shape.

7. The operating-lever sealing structure according to claim 1, wherein the sealing ring comprises a cross-section having a square shape.

8. The operating-lever sealing structure according to claim 1, wherein a plurality of concentrically-disposed sealing rings are sandwiched between the bottom surface of the fitting recess and the ceiling surface of the guard portion of the operating lever.

9. The operating-lever sealing structure according to claim 1, wherein an uplift regulating rib is provided in the housing in order to abut on an upper surface of the guard portion of the operating lever to regulate uplift.

10. An operating-lever sealing structure comprising:
an operating lever comprising a shaft portion that is turnably supported in an operation hole made in a housing of a switch; and
a sealing ring that is sandwiched between an inside opening edge portion of the operation hole of the housing and a guard portion provided in an outer circumferential surface of the shaft portion of the operating lever.

11. The operating-lever sealing structure according to claim 1,
wherein the sealing ring comprises a cross-section having a T-shape, and
wherein an inner circumferential surface of the sealing ring comprises a cyclic ridge.

12. The operating-lever sealing structure according to claim 1,
wherein the sealing ring comprises a cross-section having a C-shape, and
wherein an inner circumferential surface of the sealing ring comprises a cyclic groove portion.

13. An electric tool comprising:
a switch that comprises the operating-lever sealing structure according to claim 1.

14. The operating-lever sealing structure according to claim 2, wherein a cyclic gap is formed between an outer circumferential surface of the shaft portion and the sealing ring.

15. The operating-lever sealing structure according to claim 2,
wherein at least one position regulating cyclic groove portion in which the sealing ring is fitted is provided in at least one of the bottom surface of the fitting recess and the ceiling surface of the guard portion of the operating lever,
wherein the bottom surface of the fitting recess and the ceiling surface of the guard portion of the operating lever are opposed to each other.

16. The operating-lever sealing structure according to claim 3,
wherein at least one position regulating cyclic groove portion in which the sealing ring is fitted is provided in at least one of the bottom surface of the fitting recess and the ceiling surface of the guard portion of the operating lever,
wherein the bottom surface of the fitting recess and the ceiling surface of the guard portion of the operating lever are opposed to each other.

17. The operating-lever sealing structure according to claim 2, wherein the sealing ring comprises a cross-section having an elliptical shape.

18. The operating-lever sealing structure according to claim 3, wherein the sealing ring comprises a cross-section having an elliptical shape.

19. The operating-lever sealing structure according to claim 4, wherein the sealing ring comprises a cross-section having an elliptical shape.
